(19) United States
(12) Patent Application Publication
(10) Pub. No.: US 2022/0314649 A1
(43) Pub. Date: Oct. 6, 2022

(54) DEVICES, SYSTEMS, AND METHODS FOR CONTROLLING AIRFLOW THROUGH VACUUM PLATEN OF PRINTING SYSTEM BY ROTATING VALVE

(71) Applicant: XEROX CORPORATION, Norwalk, CT (US)

(72) Inventors: John Patrick BAKER, Rochester, NY (US); Brian M. BALTHASAR, North Tonawanda, NY (US); Emmett James SPENCE, Honeoye Falls, NY (US); Robert Jian ZHANG, Brighton, NY (US); Megan ZIELENSKI, Holland Patent, NY (US)

(73) Assignee: XEROX CORPORATION, Norwalk, CT (US)

(21) Appl. No.: 17/217,448

(22) Filed: Mar. 30, 2021

(51) Int. Cl. B41J 11/00; B41J 2/135; B41J 11/02

(52) U.S. Cl. CPC B41J 11/0085; B41J 11/007; B41J 2/135; B41J 11/02

(57) ABSTRACT

A printing system comprises an ink deposition assembly, a media transport device, and an airflow control system. The ink deposition assembly comprises printheads to deposit a print fluid, such as ink, on print media, such as paper, transported through a deposition region. The media transport device holds the print media against a movable support surface, such as a belt, by vacuum suction through holes in the media transport device and transports the print media though the deposition region. The airflow control system comprises one or more valves that are actuatable between an open state and a closed state, each valve blocking a subset of the holes in the closed state. The airflow control system also comprises one or more actuators to actuate the valve(s). The actuator(s) selectively actuate the valve(s) between the open and closed states based on a position of an inter-media zone between adjacent print media.

### FIELD

Aspects of this disclosure relate generally to inkjet printing, and more specifically to inkjet printing systems having a media transport device utilizing vacuum suction to hold and transport print media. Related devices, systems, and methods also are disclosed.

### INTRODUCTION

In some applications, inkjet printing systems use an ink deposition assembly with one or more printheads, and a media transport device to move print media (e.g., a substrate such as sheets of paper, envelopes, or other substrate suitable for being printed with ink) through an ink deposition region of the ink deposition assembly (e.g., a region under the printheads). The inkjet printing system forms printed images on the print media by ejecting ink from the printheads onto the median as the media pass through the deposition region. In some inkjet printing systems, the media transport device utilizes vacuum suction to assist in holding the print median against a movable support surface (e.g., conveyor belt, rotating drum, etc.) of the transport device. Vacuum suction to hold the print media against the support surface can be achieved using a vacuum source (e.g., fans) and a vacuum plenum fluidically coupling the vacuum source to a side of the moving surface opposite from the side that supports the print media. The vacuum source creates a vacuum state in the vacuum plenum, causing vacuum suction through holes in the movable support surface that are fluidically coupled to the vacuum plenum. When a print medium is introduced onto the movable support surface, the vacuum suction generates suction forces that hold the print medium against the movable support surface. The media transport device utilizing vacuum suction may allow print media to be securely held in place without slippage while being transported through the ink deposition region under the ink deposition assembly, thereby helping to ensure correct locating of the print media relative to the printheads and thus more accurate printed images. The vacuum suction may also allow print media to be held flat as it passes through the ink deposition region, which may also help to increase accuracy of printed images, as well as helping to prevent part of the print medium from rising up and striking part of the ink deposition assembly and potentially causing a jam or damage.

One problem that may arise in inkjet printing systems that include a media transport device utilizing vacuum suction is unintended blurring of images resulting from air currents induced by the vacuum suction. In some systems, such blurring may occur in portions of the printed image that are near the edges of the print media, particularly, but not limited to those portions that are near the lead edge or trail edge in the transport direction of the print media. During a print job, the print media are spaced apart from one another on the movable support surface as they are transported through the deposition region of the ink deposition assembly, and therefore parts of the movable support surface between adjacent print media are not covered by any print media. This region between adjacent print media is referred to herein as the inter-media zone. Thus, adjacent to both the lead edge and the trail edge of each print medium in the inter-media zone there are uncovered holes in the movable support surface. Because these holes are uncovered, the vacuum of the vacuum plenum induces air to flow through those uncovered holes. This airflow may deflect ink droplets as they are traveling from a printhead to the substrate, and thus cause blurring of the image.

A need exists to improve the accuracy of the placement of droplets in inkjet printing systems and to reduce the appearance of blur of the final printed media product. A need further exists to address the blurring issues in a reliable manner and while maintaining speeds of printing and transport to provide efficient inkjet printing systems.

### SUMMARY

Embodiments of the present disclosure may solve one or more of the above-mentioned problems and/or may demonstrate one or more of the above-mentioned desirable features. Other features and/or advantages may become apparent from the description that follows.

In accordance with at least one embodiment of the present disclosure, a printing system comprises an ink deposition assembly, a media transport device, and an airflow control system. The ink deposition assembly comprises one or more printheads arranged to eject ink to a deposition region of the ink deposition assembly. The media transport device comprises a movable support surface, and is configured to hold a print medium against the movable support surface by vacuum suction through holes in the media transport device and transport the print media along a process direction though the deposition region. The airflow control system comprises a valve actuatable between an open state and a closed state, the valve blocking airflow through a subset of the holes in the closed state, and the valve allowing airflow through the subset of holes in the open state.

In accordance with at least one embodiment of the present disclosure, a method comprises transporting a print medium through a deposition region of a printhead of a printing system, wherein the print medium is held during the transporting against a movable support surface of a media transport device via vacuum suction through holes in the media transport device; ejecting print fluid from the printhead to deposit the ink to the print medium in the deposition region; and controlling an airflow control system to selectively block a subset of the holes by actuating a valve between a closed state in which the valve blocks airflow through the subset of the holes and an open state in which the valve does not block airflow through the subset of the holes.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more embodiments of the present teachings and together with the description explain certain principles and operation. In the drawings:

FIGS. 1A-1I schematically illustrate air flow patterns relative to a printhead assembly, transport device, and print media during differing stages of print media transport through an ink deposition region of a conventional inkjet printing system, and resulting blur effects in the printed media product.

FIG. 2 is a block diagram illustrating components of an embodiment of an inkjet printing system including an air flow control system.

FIG. 3 is a schematic illustration of an ink deposition assembly, media transport device, and air flow control air flow control system of the inkjet printing system of FIG. 2.

FIG. 4 is a plan view from above the printhead assemblies of one embodiment of an inkjet printing system including an air flow control system.

FIGS. 5A-5J are cross-sectional views of the inkjet printing system of FIG. 4, with the cross-section taken along D in FIG. 4.

FIGS. 6A-6B are cross-sectional views of the inkjet printing system of FIG. 4, with the cross-section taken along E in FIG. 4.

FIGS. 7A-7B are cross-sectional views of an embodiment of an inkjet printing system, with the cross-section taken along a cross-process direction.

### DETAILED DESCRIPTION

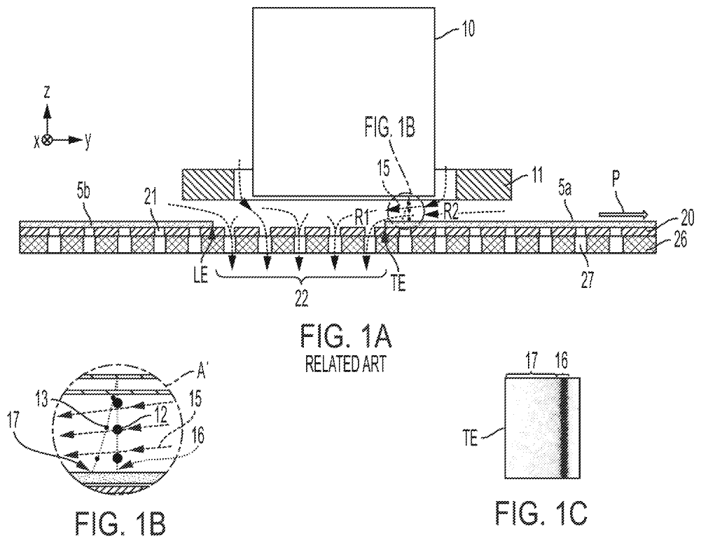

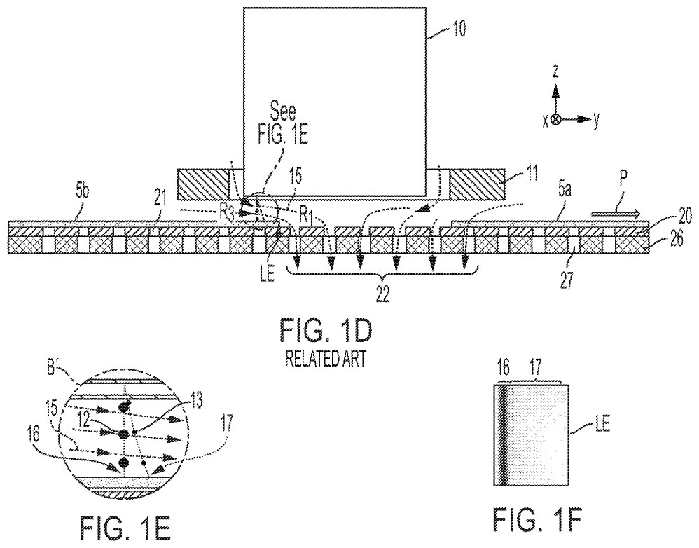

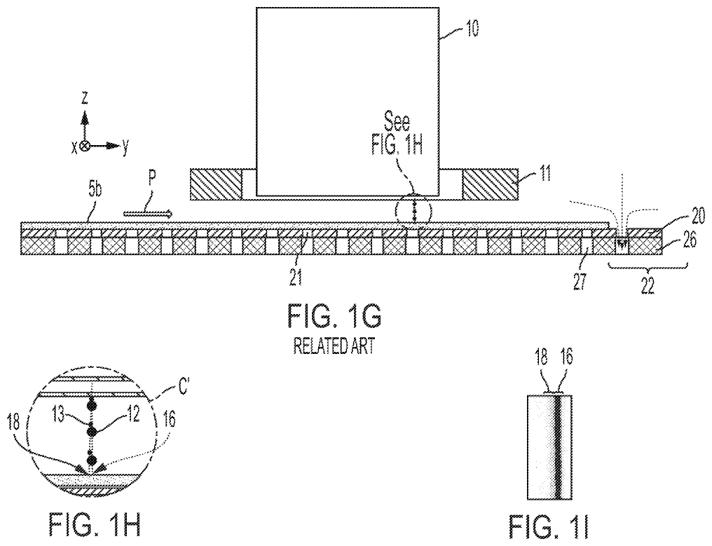

As described above, when an inter-media zone is near or under a printhead, the uncovered holes in the inter-media zone can create crossflows that can blow some ink droplets off course and cause image blur. To better illustrate some of the phenomena that gives rise to the blurring issues, reference is made to FIGS. 1A-1I. FIGS. 1A, 1D, and 1G illustrate schematically a printhead 10 printing on a print medium 5 near a trail edge TE, a lead edge LE, and a middle, respectively, of the print medium 5. FIGS. 1B, 1E, and 1H illustrate enlarged views of the regions A, B, and C, respectively. FIGS. 1C, 1F, and 1I illustrate enlarged pictures of printed images, the printed images comprising lines printed near the trail edge TE, lead edge LE, and middle, respectively, of a sheet of paper.

As shown in FIGS. 1A, 1D, and 1G, the inkjet printing system comprises a printhead 10 to eject ink to print media (print medium 5a and print medium 5b being illustrated), and a movable support surface 20 which transports the print media 5 in a process direction P, which corresponds to a positive y-axis direction in the Figures. The movable support surface 20 moves over a top of a vacuum platen 26 (in the process direction P), and a vacuum environment is provided on a bottom side of the platen 26. The movable support surface 20 has holes 21 and the vacuum platen 26 has holes 27, and the holes 21 and 27 periodically align as the movable support surface 20 moves so as to expose the region above the movable support surface 20 to the vacuum below the platen 26. In regions where one of the print media 5 covers the holes 21, the vacuum suction through the aligned holes 21 and 27 generates a force that holds the print medium 5 against the movable support surface 20. However, little or no air flows through these covered holes 21 and 27 since they are blocked by the print medium 5. On the other hand, as shown in FIGS. 1A and 1D, in the inter-media zone 22 between the print medium 5a and print medium 5b, the holes 21 and 27 are not covered, and therefore the vacuum suction pulls air to flow down through the holes 21 and 27 in the inter-media zone 22. This creates airflows, indicated by the dashed arrows in FIGS. 1A and 1D, which flow from regions around the printhead 10 (e.g., upstream and downstream of the printhead as defined relative to the process direction P) towards the uncovered holes 21 and 27 in the inter-media zone 22, with some of the airflows passing under the printhead 10.

In FIG. 1A, the print medium 5a is being printed on near its trail edge TE, and therefore the region where ink is currently being ejected (“ink-ejection region”) (e.g., the circled region in FIG. 1A) is located downstream of the inter-media zone 22. Accordingly, some of the air being sucked towards the inter-media zone 22 will flow upstream through the ink-ejection region. More specifically, the vacuum suction from the inter-media zone 22 lowers the pressure in the region immediately above the inter-media zone 22, e.g., region R₁ in FIG. 1A, while the region downstream of the printhead 10, e.g., region R₂ in FIG. 1A, remains at a higher pressure. This pressure gradient causes air to flow in an upstream direction from the region R₂ to the region R₁, with the airflows crossing through the ink-ejection region (e.g., the circled region in FIG. 1A) which is between the regions R₁ and R₂. Airflows such as these, which cross through the ink-ejection region, are referred to herein as crossflows 15. In FIG. 1A, the crossflows 15 flow upstream, but in other situations the crossflows 15 may flow in different directions.

As shown in the enlarged view A′ in FIG. 1B, which comprises an enlarged view of the circled region in FIG. 1A, as ink is ejected from the printhead 10 towards the medium 5, main droplets 12 and satellite droplets 13 are formed. The satellite droplets 13 are much smaller than the main droplets 12 and have less mass and momentum, and thus the upstream crossflows 15a tend to affect the satellite droplets 13 more than the main droplets 12. Thus, while the main droplets 12 may land on the print medium 5 near their intended deposition location 16 regardless of the crossflows 15, the crossflows 15 may entrain and sweep the satellite droplets 13 away from the intended trajectory so that they land at an unintended location 17 on the print medium 5, the unintended location 17 being displaced from the intended location 16. This can be seen in the actual printed image in FIG. 1C, in which the denser/darker line-shaped portion is formed by droplets (such as the main droplets 12 and any satellite droplets that my not have been entrained) which were deposited predominantly at their intended locations 16, whereas the smaller dots dispersed away from the line are formed by droplets (such as satellite droplets 13) that were entrained in the crossflows and blown away from the intended locations 16 to land in unintended locations 17, resulting in a blurred or smudged appearance for the printed line. Notably, the blurring in FIG. 1C is asymmetrically biased towards the trail edge TE, due to the crossflows 15 near the trail edge TE blowing primarily in an upstream direction. The inter-media zone 22 may also induce other airflows flowing in other directions, such as downstream airflows from an upstream side of the printhead 10, but these other airflows do not pass through the region where ink is currently being ejected in the illustrated scenario and thus do not contribute to image blur. Only those airflows that cross through the ink ejection region are referred to herein as crossflows.

FIGS. 1D-1F illustrate another example of such blurring occurring, but this time near the lead edge LE of the print medium 5b. The cause of blurring near the lead edge LE as shown in FIGS. 1C and 1D is similar to that described above in relation to the trail edge TE of print medium 5a, except that in the case of printing near the lead edge LE the ink-ejection region is now located upstream of the inter-media zone 22. As a result, the crossflows 15 that are crossing through the ink-ejection region now originate from the upstream side of the printhead 10, e.g., from region R₃, and flow downstream. Thus, as shown in the enlarged view B′ of FIG. 1E, which comprises an enlarged view of the circled region of FIG. 1D, in the case of printing near the lead edge LE, the satellite droplets 13 are entrained and blown downstream towards the lead edge LE of the print medium 5b (positive y-axis direction). As shown in FIG. 1F, this results in asymmetric blurring that is biased towards the lead edge LE of the print medium.

In contrast, as shown in FIG. 1G and the enlarged view C′ in FIG. 1H, which corresponds to an enlarged view of the circled region in FIG. 1G, farther from the edges of the print media 5 there may be little or no crossflows 15 because the inter-media zone 22 is too distant to induce much airflow. Because the crossflows 15 are absent or weak farther away from the edges of the print medium 5, the satellite droplets 13 in this region are not as likely to be blown off course. Thus, as shown in FIGS. 1H and 1I, when printing farther from the edges of the print medium 5b, the satellite droplets land at locations 18 that are much closer to the intended locations 16 resulting in much less image blurring. The deposition locations 18 of the satellite droplets may still vary somewhat from the intended locations 16, due to other factors affecting the satellite droplets 13, but the deviation is smaller than it would be near the lead or trail edges.

Embodiments disclosed herein may, among other things, reduce or eliminate such image blur by utilizing an airflow control system that reduces or eliminates the crossflows. With the crossflows reduced or eliminated, the satellite droplets are more likely to land closer to or at their intended deposition locations, and therefore the amount of blur is reduced. Airflow control systems in accordance with various embodiments reduce or eliminate the crossflows by selectively blocking holes of the media transport device near the printheads when the inter-media zone is near or under the printheads. In various embodiments, a series of valves are positioned to selectively block holes in the platen of the transport device. The series of valves are rotatable between a closed state and an open state. In the closed state, a portion of the valve is positioned against or sufficiently close to the bottom side of the platen under a subset of holes (e.g., one or more rows) and thus blocks airflow through those holes. In the open state, the valve is rotated to unblock airflow through the holes. The valves may be rotary valves that have a central passage that moves into flow communication with holes of the platen to allow airflow to the platen from the vacuum plenum and that moves out of flow communication with the holes such that the valve body blocks the holes and airflow to the platen. The timings at which the valves are moved between open and closed states may be controlled based on the location of the inter-media zone such that the valves block holes in the platen near the printhead when the intermedia zone is above those holes, thereby preventing the holes in the platen that are under an inter-media zone from sucking in air and creating the crossflows. The valves may be moved to the open state when the inter-media zone has passed the holes in the platen under the printhead, so as allow the holes to resume applying hold down force to a print medium being printed by the printhead. With the crossflows reduced or eliminated, the satellite droplets are more likely to land nearer their intended deposition locations, and therefore the amount of blur is reduced.

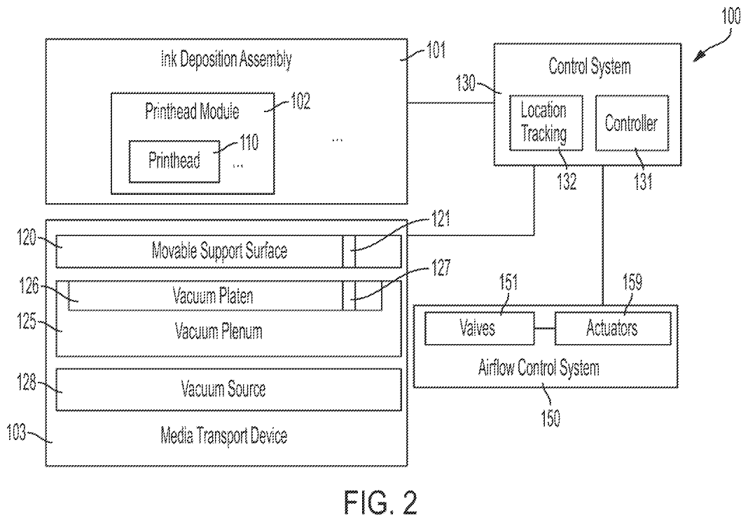

FIG. 2 is a block diagram illustrating components of a printing system 100 printing system utilizing an embodiment of an air flow control system comprising rotary valves as described above. The printing system 100 comprises an ink deposition assembly 101, a media transport device 103, an airflow control system 150, and a control system 130. These components of the printing system 100 are described in greater detail in turn below.

The ink deposition assembly 101 comprises one or more printhead modules 102. One printhead module 102 is illustrated in FIG. 2 for simplicity, but any number of printhead modules 102 may be included in the ink deposition assembly 101. In some embodiments, each printhead module 102 may correspond to a specific ink color, such as cyan, magenta, yellow, and black. Each printhead module 102 comprises one or more printheads 110 configured to eject ink onto the print media to form an image. In FIG. 2, one printhead 110 is illustrated in the printhead module 102 for simplicity, but any number of printheads 110 may be included per printhead module 102. In some embodiments, described further below, each printhead module can include three printheads, but such is nonlimiting and exemplary only. The printhead modules 102 may also include additional structures and devices to support and facilitate operation of the printheads 110, such as carrier plates 111, ink supply lines, ink reservoirs, electrical connections, and so on, as is familiar to those having ordinary skill in the art.

As shown in FIG. 2, the media transport device 103 comprises a movable support surface 120, a vacuum plenum 125, and a vacuum source 128. The movable support surface 120 transports the print media through a deposition region of the printing assembly 101. The vacuum plenum 125 supplies vacuum suction to one side of the movable support surface 120 (e.g., a bottom side), and print media is supported on an opposite side of the movable support surface 120 (e.g., a top side). Air holes 121 through the movable support surface 120 communicate the vacuum suction through the surface 120, such that the vacuum suction holds down the print media against the surface 120. The movable support surface 120 is movable relative to the printing assembly 101, and thus the print media held against the movable support surface 120 is transported relative to the printing assembly 101 as the movable support surface 120 moves. Specifically, the movable support surface 120 transports the print media through a deposition region of the printing assembly 101, the deposition region being a region in which print fluid (e.g., ink) is ejected onto the print media, such as a region under the printhead(s) 110. The movable support surface 120 can comprise any structure capable of being driven to move relative to the printing assembly 101 and which has air holes 121 to allow the vacuum suction to hold down the print media. Such structures can include, but are not limited to, for example a belt, one or more rotatable drums, etc. Those having ordinary skill in the art are familiar with various movable support structures used in printing systems to convey the print media. The vacuum plenum 125 comprises baffles, walls, or any other structures arranged to enclose or define an environment in which a vacuum state (e.g., low pressure state) is maintained by the vacuum source 128, with the plenum 125 fluidically coupling the vacuum source 128 to the movable support surface 120 such that the movable support surface 120 is exposed to the vacuum state within the vacuum plenum 125. In some embodiments, the movable support surface 120 is supported by a vacuum platen 126, which may be a top wall of the vacuum plenum 125. In such an embodiment, the movable support surface 120 is fluidically coupled to the vacuum in the plenum 125 via air holes 127 through the vacuum platen 126. In some embodiments, the movable support surface 120 is itself one of the walls of the vacuum plenum 125 and thus is exposed directly to the vacuum in the plenum 125. The vacuum source 128 may be any device configured to remove air from the plenum 125 to create the low-pressure state in the plenum 125, such as a fan, a pump, etc.

The control system 130 comprises processing circuitry to control operations of the printing system 100. The processing circuitry may include one or more electronic circuits configured with logic for performing the various operations described herein. The electronic circuits may be configured with logic to perform the operations by virtue of including dedicated hardware configured to perform various operations, by virtue of including software instructions executable by the circuitry to perform various operations, or any combination thereof. In examples in which the logic comprises software instructions, the electronic circuits of the processing circuitry include a memory device that stores the software and a processor comprising one or more processing devices capable of executing the instructions, such as, for example, a processor, a processor core, a central processing unit (CPU), a controller, a microcontroller, a system-on-chip (SoC), a digital signal processor (DSP), a graphics processing unit (GPU), etc. In examples in which the logic of the processing circuitry comprises dedicated hardware, in addition to or in lieu of the processor, the dedicated hardware may include any electronic device that is configured to perform specific operations, such as an Application Specific Integrated Circuit (ASIC), a Field Programmable Gate Array (FPGA), a Complex Programmable Logic Device (CPLD), discrete logic circuits, a hardware accelerator, a hardware encoder, etc. The processing circuitry may also include any combination of dedicated hardware and general-purpose processor with software.

The airflow control system 150 comprises one or more valves 151 and corresponding actuators 159. The valves 151 are disposed inside the vacuum plenum 125 on a side of the vacuum platen 126 opposite from the movable support surface 120 (e.g., the bottom side of the platen 126 in the perspective of the Figures) with each valve 151 extending in a cross-process direction under a corresponding subset of platen holes 127, such as one or more rows of holes 127. Each valve 151 is configured to be independently actuatable by the corresponding actuator 159 between an open state and a closed state to selectively block the subset of platen holes 127. For example, the valves 151 may comprise elongated ball valves having a solid body to block air flow and a central opening through the body to allow air flow. In the closed state, the body of the valve 151 is positioned to engage with the bottom side of the vacuum platen 126 and/or with seals coupled to the platen 126 (e.g., seals 354 described below) such that the valve blocks airflow through each hole 127 in its corresponding subset of holes 127. In the open state, the valve 151 is rotated such that it ceases to block the holes 127 in its corresponding subset of holes 127 and allows air to flow through valve 151 between the platen 127 and the vacuum plenum 125.

Each of the valves 151 is positioned near a corresponding one of the printheads 110 so as to block a subset of holes 127 that are near (e.g., under in an ink deposition region of) the printhead 110. For example, in some embodiments, a group of valves 151 associated with a given printhead 110 are positioned to collectively block (when closed) all of the holes 127 that are located under the given printheads 110 and in the respective ink deposition regions of the printheads. Thus, in some embodiments, all of the holes 127 that are under any of the printheads 110 are blocked by corresponding valves 151. In some embodiments valves 151 are provided to block holes 127 that are adjacent to, but not under, the printheads 110, such as holes 127 immediately upstream or downstream of each printhead 110. In some embodiments, the valves 151 are arranged to collectively block both the holes 127 under the printheads 110 and also holes 127 adjacent to the printhead 110. In some embodiments, each printhead module 102 may have a number of valves 151 associated therewith, and the valves 151 associated with a given printhead module 102 may be arranged to collectively block each row of holes 127 that is located under the given printhead module 102. In some embodiments, the subset of holes 127 blocked by a given valve 151 may comprise more than one rows of holes 127. In other embodiments, each valve 151 may block an individual row of holes 127. In some embodiments, one or more valves 151 may extend across a width of the platen 126 to block an entire row or rows of holes 127. In some embodiments, one or more valves 151 may extend less than the full width of the platen 126 and block only part of a row or rows of holes 127. It is also contemplated as within the scope of the disclosure that a valve that is dedicated to a row or rows of holes may only be configured to allow selective blocking and unblocking of some holes in each row or rows, which those having ordinary skill in the art would appreciate could be chosen based on desired airflow and suction forces.

The actuator 159 is a device configured to drive actuation of a valve 151, such as an electric motor, hydraulic or pneumatic rotary actuator, etc. In various embodiments, explained below, the actuator 159 may be configured to actuate the valve by causing the valve to rotate around an axis of rotation, such as a longitudinal axis of the valve extending in the cross-process direction (x-axis). The actuator 159 may utilize electrical motive power, hydraulic motive power, pneumatic motive power, or any other desired motive power.

The airflow control system 150 is configured to selectively block the subset of holes 127 based on the location of the inter-media zone 122, or in other words based on the locations of the lead edges LE and trail edges TE of the print media 105. “Selectively” in this context refers to the capability of the airflow control system 150 to independently move a valve 151, during printing operations of the printing system 100, between closed and open states in which a subset of holes 127 associated with a valve 151 are blocked and not blocked, respectively. Moreover, selectively blocking the holes based on the location of the inter-media zone can occur by the airflow control system 150 independently actuating a valve 151 at timings that correspond to particular positions of the inter-media zone 122—e.g., particular positions of the inter-media zone 122 are used as triggers for closing and opening the valve 151. As will be explained further below, a determination of where an inter-media zone is located may be made based on detecting positions of the print media. The positions used to trigger actuation of the valves 151 may be predetermined parameters which are programmed into a controller 131 and remain static during operation, or the positions may be dynamic parameters which can be automatically varied/updated during run-time. The controller 131 comprises one or more electronic circuits, like those described above in relation to the control system 130, and may be considered as being part of the airflow control system 150, part of the overall control system 130, or both.

In some embodiments, each valve 151 is moved into the closed state when the inter-media zone 122 is located near or under the corresponding printhead 110 or printhead module 102 associated with the valve 151. More specifically, in some embodiments, each valve 151 is in the closed state when the downstream edge of the inter-media zone 122 (which corresponds to the trail edge TE of a print medium 105) is at an upstream position associated with the valve 151. Conversely, each valve 151 is in the open state when the upstream edge of the inter-media zone 122 (which corresponds to the lead edge LE of a print medium 105) reaches a downstream position associated with the valve 151. In some embodiments, the upstream position associated with a given valve 151 is an upstream edge of the valve 151 and the downstream position associated with the valve 151 is a downstream edge of the valve 151. In some embodiments, the upstream position associated with a given valve 151 is an upstream boundary of the subset of holes 127 blocked by the valve 151, and the downstream position associated with the valve 151 is a downstream boundary of the subset of holes 127 blocked by the valve 151. In some embodiments, the upstream position associated with a given valve 151 is any predetermined position on an upstream side of the valve 151, while the downstream position associated with the given valve 151 is any predetermined position on a downstream side of the valve 151. In some embodiments, rather than closing and opening a valve 151 based on the location of the inter-media zone 122 relative to the valve 151, the valve 151 may be closed and opened based on the location of the inter-media zone 122 relative to some other object or location, such as the printhead 110, printhead module 102, etc.

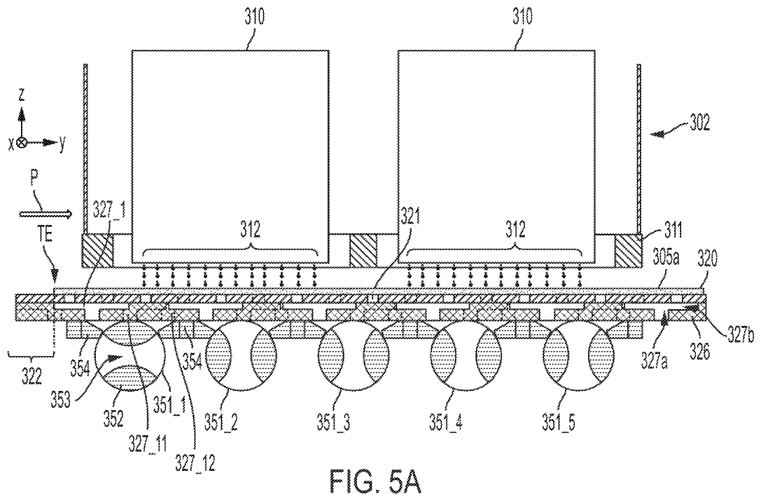

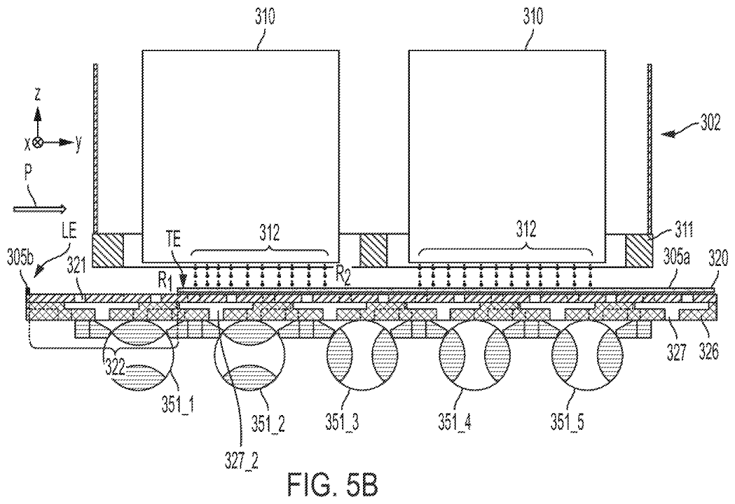

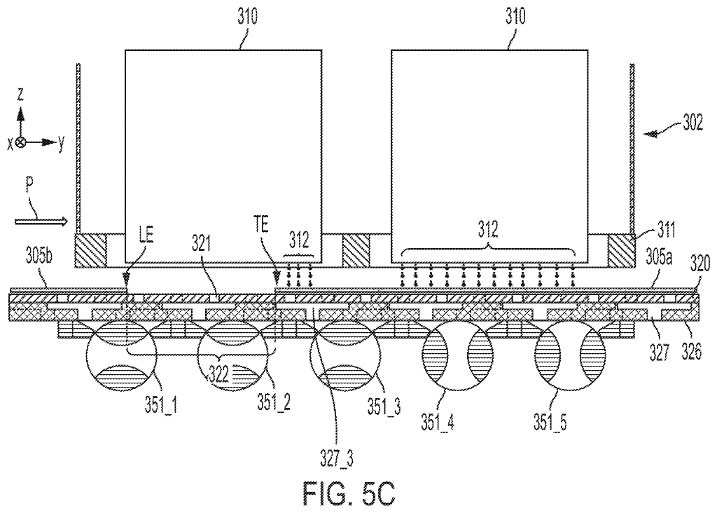

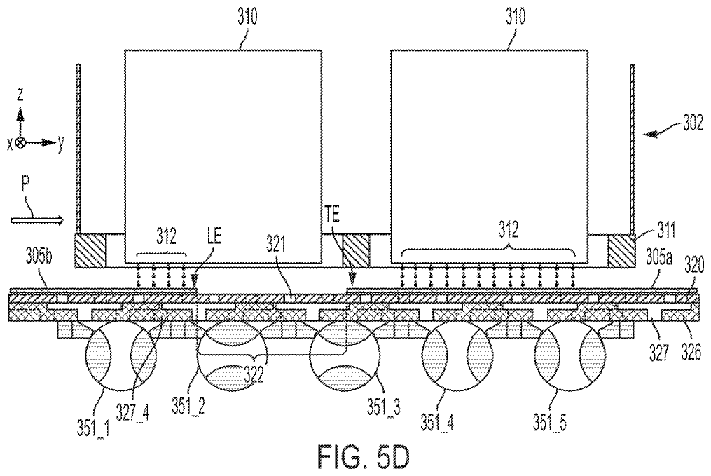

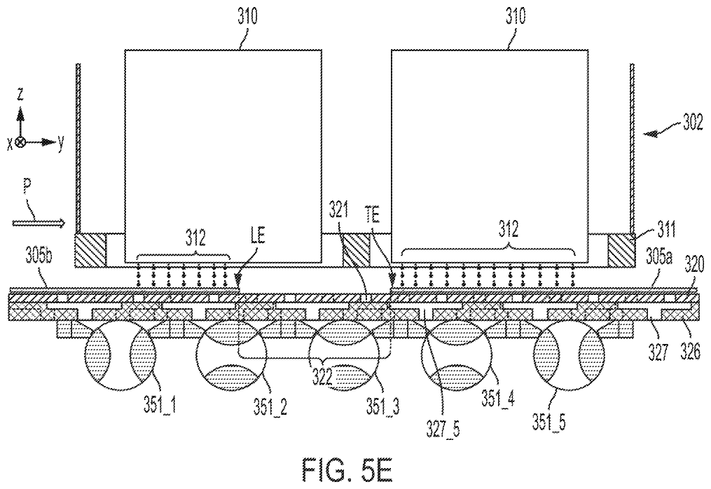

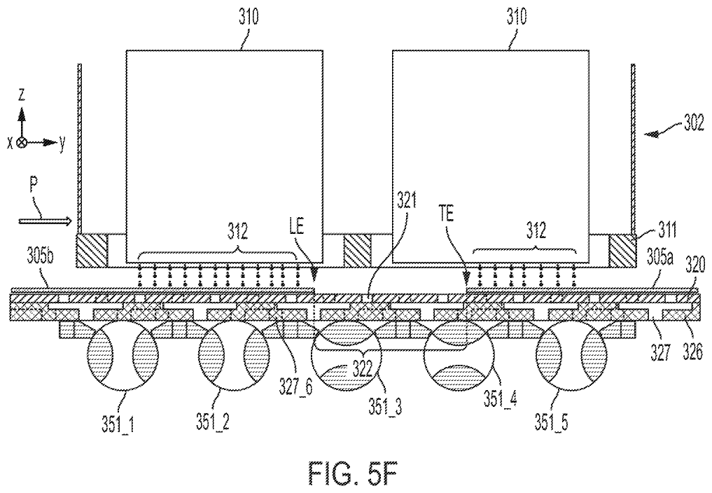

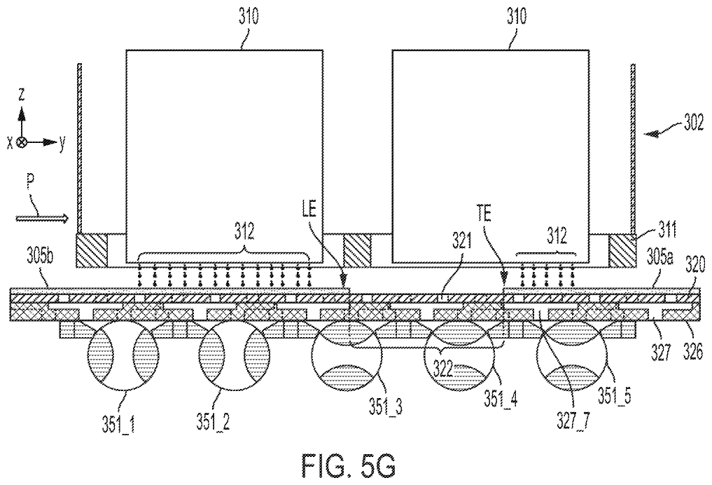

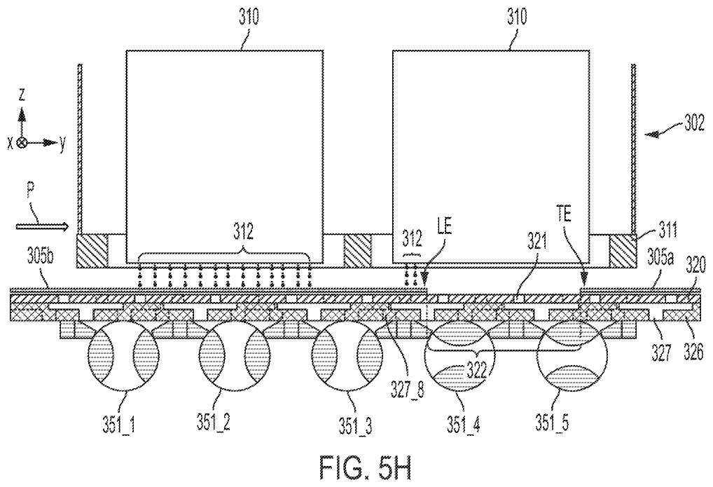

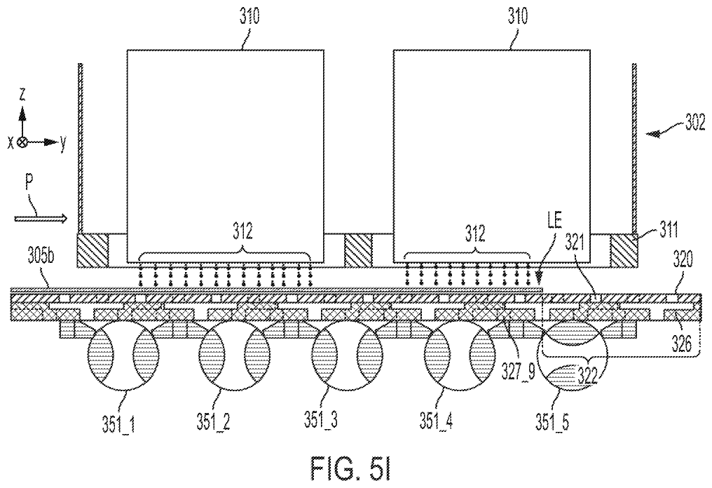

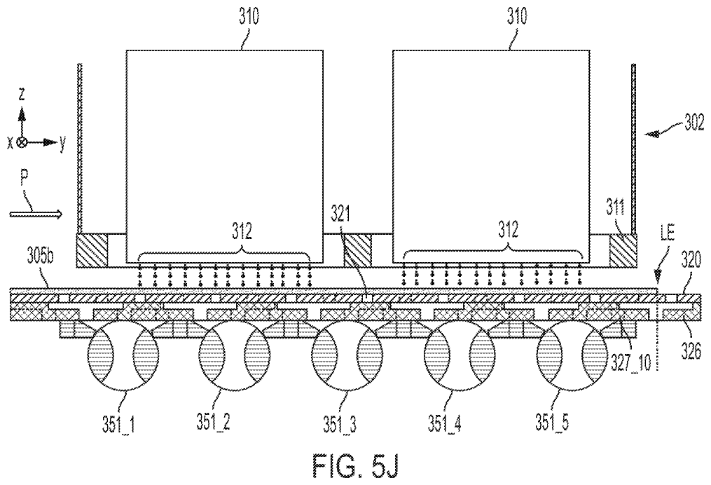

Thus, in some embodiments, a given valve 151 is closed whenever (at least part of) the inter-media zone 122 is located above the given valve 151 and is opened when the inter-media zone 122 has moved past the given valve 151. Moreover, in some embodiments, a group of valves 151 are positioned throughout a region under a printhead module 102 to collectively block airflow through any portion of the inter-media zone 122 that is located under a printhead 110 as the inter-media zone 122 moves under the printhead module 102. An arrangement and actuation of the valves 151 in accordance with one embodiment are discussed in greater detail below in relation to FIGS. 5A-5F.

An issue associated with blocking holes 127 is that it can interfere with the hold down force being applied to the print media. For example, if the holes 127 near the printheads 110 were permanently blocked or eliminated entirely, this would permanently reduce or eliminate all hold down force in the vicinity of the printheads 110, which might in some circumstances result in the leading edge of a print medium rising off the movable support surface 120, potentially causing jams in the printing system and/or less accurate printing of images on the print medium. In contrast, in the approach described above, the valves 151 are closed only for a period of time corresponding generally to the inter-media zone 122 moving past the valve 151/printhead 110 and the valves 151 are opened thereafter. In this way, the hold down force may be applied without interference for most of the printing process. Moreover, even while the valves 151 are closed, their interference with the hold down force is sufficiently small that the risk of the print media 105 rising off the movable support surface 120 is eliminated or acceptably small. In particular, for most of the period in which a valve 151 is closed, the holes 127 that are blocked by the valve 151 are not covered by any print medium (i.e., the inter-media zone 122 is above the valve 151), and therefore the valve 151 is not interfering with the hold down of any print medium. The valves 151 may block some holes 127 covered by a print medium briefly, for example near the edges of the inter-media zone 122, but because the valves 151 are closed and opened based on the position of the inter-media zone, generally only a relatively few of the holes 127 covered by a print medium are blocked at by the valves 151 at any given time. Thus, the portion of the print medium that is not actively being subjected to hold down suction at any given time is kept relatively small. Accordingly, although closing the valves 151 does reduce the hold down force on the print medium in the vicinity of the valves, the reduction in hold down force is sufficiently limited in time and space that the print media 105 is still held against the movable support surface 120 with a force sufficient to prevent the print media from lifting off and/or slipping relative to the movable support surface 120. In addition, as described further below, the reduction in hold down force due to the valves 151 can be further tuned, if desired, by providing unblocked regions and/or adjusting the width and number of the valves 151.

A controller, which may be part of the control system 130, is configured to determine when to close and open the valves 151. The controller also generates signals to control the actuators 159 to cause the actuators 159 to move the valves 151 at the determined timings. The controller comprises one or more electronic circuits configured with logic to perform the options described herein. In some embodiments, the electronic circuits of the controller are part of the processing circuitry of the control system 130 described above, and therefore the controller is not separately illustrated in FIG. 2.

A location tracking system 132 may be used to track the locations of the inter-media zones 122 and/or print media as the print media are transported through the ink deposition assembly. As used herein, tracking the location of the inter-media zones 122 or the print media refers to the system having knowledge, whether direct or inferred, of where the print media are located at various points as they are transported through the ink deposition assembly 101. Direct knowledge of the locations of the inter-media zones 122 or print media may comprise information obtained by directly observing the print media, for example via a sensor (e.g., an edge detection sensor). Inferred knowledge of the locations of the inter-media zones 122 or print media may be obtained by inference from other known information, for example by calculating how far a print medium would have moved from a previously known location based on a known speed of the movable support surface 120. In some embodiments, the location tracking system 132 may explicitly track locations of the inter-media zones 122, the lead edges LE of print media, and/or the trail edges TE of print media. In other embodiments, the location tracking system may explicitly track the locations of some other parts of the print media. Because the locations of the inter-media zones 122 depend deterministically on the locations of the print media and on the dimensions of the print media (which are generally known in advance by the control system 130), those having ordinary skill in the art would understand that tracking the locations of any part of the print media is functionally equivalent to tracking the locations of the inter-media zones 122. The location tracking system 132 may be part of the control system 130, as illustrated in FIG. 2, or may be a separate component.

Conventional printing systems are already configured to track the locations of the print media as they are transported through the ink deposition assembly, as knowledge of the locations of the print media may be helpful to ensure accurate image formation on the print media. Thus, various systems for tracking the locations of print media are well known to those having ordinary skill in the art and are not described in detail herein. Any known location tracking system (or any new location tracking system) may be used in the embodiments disclosed herein to track the location of print media, and a controller may use this information to determine the locations of the lead edge LE and/or the trail edge TE (if not already known).

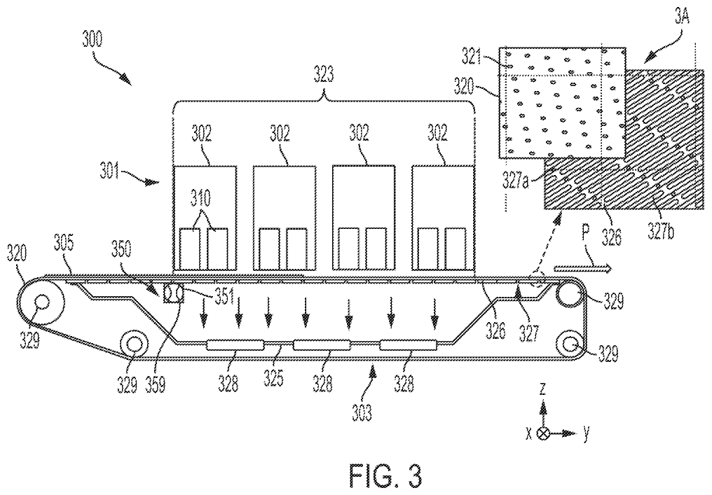

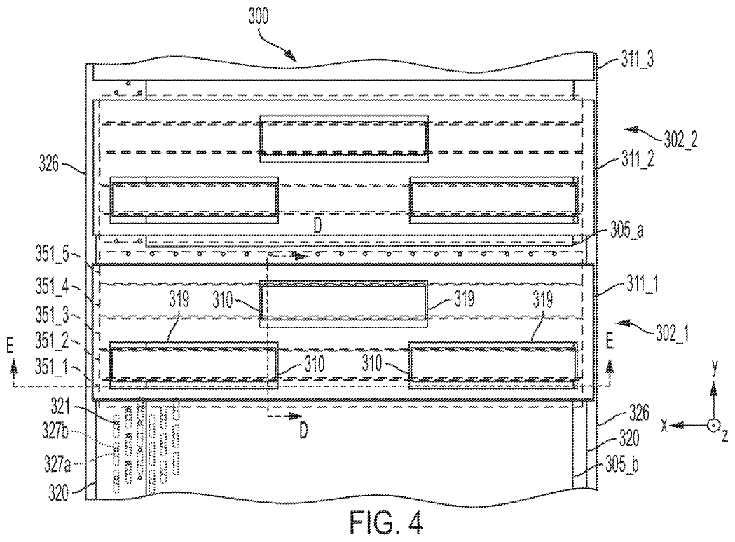

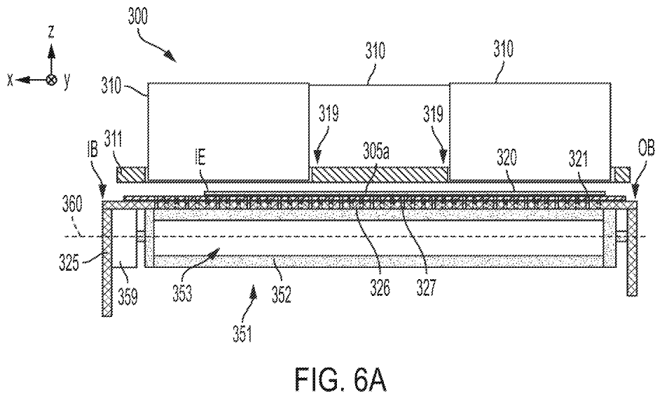

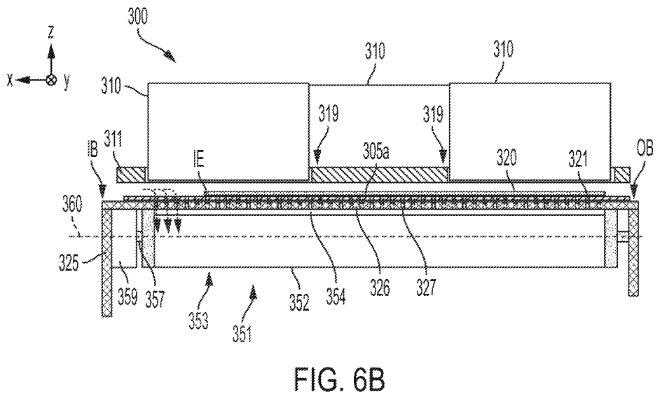

FIGS. 3-6B illustrate another embodiment of a printing system 300, which may be used as the printing system 100 described above with reference to FIG. 2. FIG. 3 comprises a schematic illustrating a portion of the printing system 300 from a side view. FIG. 4 comprises a plan view from above a portion of the printing system 300. In FIG. 4, some components that would not otherwise be visible in the view because they are positioned below other components are illustrated with dashed or dotted lines. FIGS. 5A-5K comprise cross-sections of the printing system 300 with the section taken along line D-D in FIG. 4, with each of FIGS. 5A-5K showing a sequence of states as the print media 305a and 305b are transported past one of the printhead modules 302. FIGS. 6A-6B comprise cross-sections of the printing system 300 with the section taken along line E-E in FIG. 4, with FIG. 6A illustrating a valve 351 in a closed state and FIG. 6B illustrating the valve 351 in an open state.

As illustrated in FIG. 3, the printing system 300 compromises an ink deposition assembly 301, a media transport device 303, and an airflow control system 350, which can be used as the ink deposition assembly 101, media transport device 103, and airflow control system 150, respectively. The printing system 300 may also comprise additional components not illustrated in FIGS. 3-6B, such as a control system (e.g., the control system 130).

In the printing system 300, the ink deposition assembly 301 comprises four printhead modules 302 as shown in FIG. 3, with each module 302 having three printheads 310 as shown in FIG. 4. As shown in FIGS. 3 and 4, the printhead models 302 are arranged in series along a process direction P above the media transport device 303, such that the print media 305 is transported sequentially beneath each of the printhead modules 302. The printheads 310 are arranged to eject print fluid (e.g., ink) through respectively corresponding openings 319 in a corresponding carrier plate 311 (shown in FIG. 4), with a bottom end of the printhead 310 extending down partway into the opening 319. In this embodiment, the printheads 310 are arranged in an offset pattern with one of the printheads 310 being further upstream or downstream than the other two printheads 310 of the same printhead module 302. In other embodiments, different numbers and/or arrangements of printheads 310 and/or printhead modules 302 are used.

In the printing system 300, media transport device 303 comprises a flexible belt providing the movable support surface 320. As shown in FIG. 3, the movable support surface 320 is driven by rollers 329 (the number and arrangement of which in FIG. 3 is nonlimiting as those of ordinary skill in the art would appreciate) to move along a looped path, with a portion of the path passing through the ink deposition region 323 of the ink deposition assembly 301. Furthermore, in this embodiment, the vacuum plenum 325 comprises a vacuum platen 326, which forms a top wall of the plenum 325 and supports the movable support surface 320. The platen 326 comprises platen holes 327, which allow fluidic communication between the interior of the plenum 325 and the underside of the movable support surface 320.

In some embodiments, the platen holes 327 may include channels on a top side thereof, as seen in the expanded cutaway 3A of FIG. 3, which may increase an area of the opening of the holes 327 on the top side thereof. Specifically, the platen holes 327 may include a bottom portion 327a which opens to a bottom side of the platen 326 and a top portion 327b which opens to a top side of the platen 326, with the top portion 327b being differently sized and/or shaped than the bottom portion 327a. For example, FIGS. 3-5F illustrate an embodiment of the platen holes 327 in which the top portion 327b is a channel elongated in the process direction while the bottom portion 327a is a through-hole that is less-elongated and has a smaller sectional area (see the enlargement D in FIG. 3 and the dashed-lines in FIG. 4). In some embodiments, multiple holes 327 may share the same top portion 327b, or in other words multiple bottom portions 327a may be coupled to the same top portion 327b. References herein to the valves 351 blocking a hole 327 refer to blocking at least the bottom portion 327a of the hole 327.

The holes 327 are arranged in columns extending in the process direction P and rows extending in a cross-process direction (the x-direction shown in FIGS. 3 and 4), with each column comprising a group of holes 327 that are aligned with one another in the process direction P and each row comprising a group of one or more holes 327 aligned with one another in a cross-process direction. In some embodiments, the columns and rows are arranged in a regular grid, but in other embodiments the columns and rows are arranged in other patterns that do not form a regular grid. For example, in some embodiments, such as the embodiment of FIG. 4, the holes 327 (top portion 327b, bottom portions 327a, or both) of two adjacent columns may be offset or staggered from one another in the process direction P—in other words, a hole 327 in one column may not be aligned in the cross-process direction with any holes 327 in an adjacent column. Similarly, in some embodiments the holes 327 (top portion 327b, bottom portion 327a, or both) of two adjacent rows are offset or staggered from one another in the cross-process direction—in other words, a hole 327 in one row may not be totally aligned in the process direction with any holes 327 in an immediately adjacent row. In some embodiments, the holes 327 (top portion 327b, bottom portion 327a, or both) in each individual column are arranged with uniform spacing in the process direction, but in other embodiments some or all of the holes 327 in one or more columns may have non-uniform spacings. In some embodiments, the holes 327 (top portion 327b, bottom portion 327a, or both) in each individual row are arranged with uniform spacing in the cross-process direction, but in other embodiments some or all of the holes 327 in one or more rows may have non-uniform spacings. In some embodiments, each column has the same number of holes 327 as the other columns and/or each row has the same number of holes 327 as the other rows, but in some embodiments some or all of the columns and/or rows have differing numbers of holes 327. In embodiments in which the holes 327 have bottom portions 327an and top portions 327b with different shapes/sizes, references herein to the holes 327 being aligned refer to the bottom portions 327a of the holes being 327 aligned.

The holes 321 of the movable support surface 320 are disposed such that each hole 321 is aligned in the process direction P (y-axis direction) with a collection of corresponding platen holes 327. In other words, in the printing system 300, each hole 321 is aligned in the with one of the columns of platen holes 327. Thus, as the movable support surface 320 slides across the platen 326, each hole 321 in the movable support surface 320 will periodically move over a corresponding platen hole 327, resulting in the movable support surface hole 321 and the platen hole 327 being temporarily vertically aligned (i.e., aligned in a z-axis direction). When a hole 321 of the movable support surface 320 moves over a corresponding platen hole 327, the holes 321 and 327 define an opening that fluidically couples the environment above the movable support surface 320 to the low-pressure state in the vacuum plenum 325, thus generating vacuum suction through the holes 321 and 327. This suction generates a vacuum hold down force on a print medium 305 if the print medium 305 is disposed above the hole 321.

As shown in FIGS. 3-6B, the airflow control system 350 comprises valves 351 and corresponding actuators 359 to move the valves 351. The valves 351 and actuators 359 of FIGS. 3-6B may be used as the valves 151 and actuators 159 described above in relation to FIG. 2. To simplify the illustrations, one valve 351 and one actuator 359 are illustrated in FIG. 3, and FIGS. 4-5K illustrate five valves 351 per printhead module 302, but in practice any number of valves 351 and actuators 359 may be provided per printhead 310 and/or per printhead module 302. In some embodiments, valves 351 are provided to collectively block holes 327 that are located under the printheads 310. For example, in some embodiments, valves 351 are provided to collectively block at least all of the holes 327 that are located under any of printheads 310. In some, embodiments valves 351 are provided to block holes 327 that are adjacent to, but not under, the printheads 310, such as holes 327 immediately upstream or downstream of each printhead 310. In some embodiments, for each printhead 310, valves 351 are provided to collectively block the holes 327 that are located under the printhead 310 and also to block holes adjacent to (e.g., immediate upstream or downstream of) the printhead 310. In some embodiments, the valves 351 are provided to collectively block all of the holes 327 that are located under any carrier plate 311 of a printhead module 302.

As shown in FIGS. 3 and 6A, in the printing system 300 the valves 351 are disposed against a bottom surface of the platen 326 and extend across the platen 326 in a cross-process (x-axis) direction. In this embodiment, the valves 351 are configured as elongated ball valves, with a longitudinal axis extending in the x-direction. For example, the valves 351 have a generally cylindrical body 352 which blocks airflow in a closed state, and there are one or more passages 353 extending diametrically through the cylindrical body to allow airflow in an open state. In the illustrated embodiment, a single passage 353 extends diametrically through the cylindrical body and spans nearly the entire length of the body (see FIGS. 6A-6B).

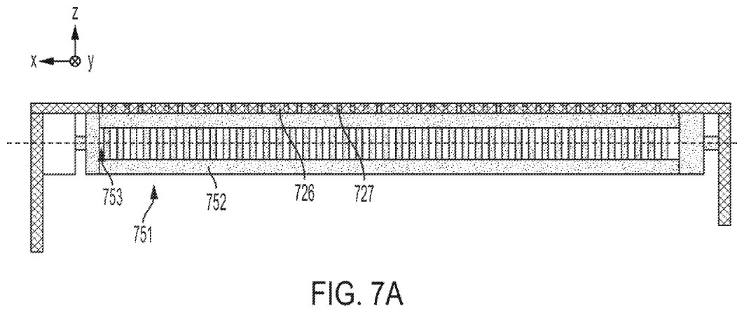

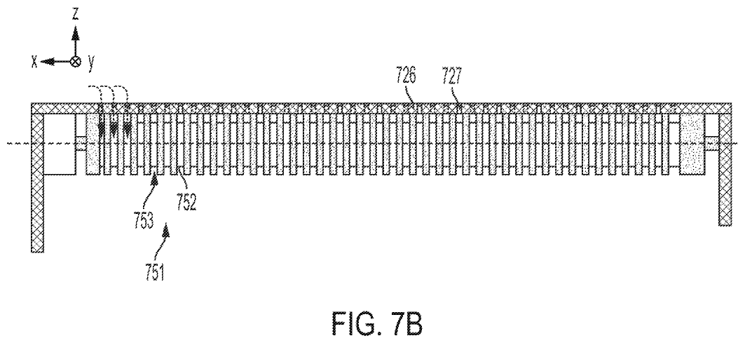

In other embodiments, such as shown in FIGS. 7A and 7B, a valve 751 may comprise multiple passages 753. The passages 753 can extend diametrically through the cylindrical body 752 and be spaced from each other and distributed along the length of the valve 751, such as one passage 753 for each column of holes 727 in the platen 726 or one passage 753 per group of multiple columns. FIG. 7A illustrates such a valve 751 in the closed state, while FIG. 7B illustrates the valve 751 in an open state. In this embodiment, other aspects of the printing system and airflow control system may be similar to any of the other described embodiments, and thus detailed description of the other components is omitted.

Returning to the embodiment of FIGS. 5A-6B, each valve 351 may also comprise a pair of seals 354 which interact with the body 352 of the valve 351 in the closed state to block airflow. The seals 354 may extend across the platen 326 in the cross-process direction and may be fixed relative to the platen 326 on opposite sides of the row or rows comprising the subset of holes 327 associated with the valve.

The width of the valves 351 in the process direction P determines how many rows of holes 327 are blocked/unblocked by each individual valve 351. Each valve 351 extends in the process direction a sufficient distance to block holes 327 from at least one row of holes 327. In FIGS. 5A-5J, each valve 351 blocks three rows of holes 327. For example, the first valve 351_1 illustrated in FIG. 5A is associated with three rows of holes 327—i.e., the rows corresponding to holes 327_1, 327_11, and 327_12 illustrated in FIG. 5A—and the seals 354 of the first valve 351_1 are thus arranged on either side of these three rows of holes 327. In FIGS. 5A-J some of the holes 327, such as the holes 327_11, and 327_12, would be blocked from view in the figure because they are located in columns that are offset from the section line. In other embodiments each valve 351 could be narrower or wider in the process direction to block fewer or more rows of holes, including, for example, one row of holes per valve 351, two rows of holes per valve 351, or any other number of rows of holes per valve 351. Moreover, although FIGS. 4-5J illustrate the valves 351 has having similar widths in the process direction such that each blocks the same number of rows, in some embodiments one or more of the valves may have different widths than others and may block different numbers of rows. Providing more valves 351 which are narrower in the process direction may allow for more fine-grained control over which rows of holes 327 are blocked, which may reduce the impact of the valves 351 on the ability to maintain hold-down of the print media 305. On the other hand, providing fewer valves 351 which are wider may allow for simpler control and allow for fewer actuators 359, which may reduce the cost, size, and/or complexity of the system.

The actuator 359 drives the movement of the valve 351 between the closed and open states, as will be described in greater detail below with reference to FIGS. 6A-6B. As described above, the airflow control system 350 is configured to close and open the valves 351 at timings based on the position of the inter-media zone 322. Specifically, in the printing system 300a, a given valve 351 is closed when the inter-media zone 322 arrives at an upstream position associated with the valve 351, i.e., when the trail edge TE of a print medium 305 reaches the upstream position. The valve 351 is opened when the inter-media zone 322 has passed a downstream position associated with the valve 351, i.e., when the lead edge LE of a print medium 305 reaches the downstream position. In other words, in some embodiments, each valve 351 is closed when the inter-media zone 322 approaches the valve 351 and remains closed until the inter-media zone 322 has moved past the valve 351. Thus, as the inter-media zone 322 moves past the printheads 310, the valves 351 close and open in concert with the movement of the inter-media zone 322 to collectively block all of the uncovered holes 327 that are near a printhead 310. The valves 351 thus prevent the inter-media zone 322 from inducing crossflows. The opening of a valve 351 once the inter-media zone has passed it allows the now-unblocked holes 327 associated with that valve 351 to resume their intended role of holding down the print media 305.

The timings for closing and opening the valves 351 in the printing system 300 are explained in greater detail below with reference to FIGS. 5A-5J, which illustrate various positions of the inter-media zone 322 at which closing or opening of the valves 351 are triggered. Each valve 351 has a first trigger location and a second trigger location associated with it, and the valve 351 is closed when the inter-media zone 322 reaches a position associated with the first trigger location and is opened when the inter-media zone 322 reaches a position associated with the second trigger location, which is downstream of the first trigger location. FIGS. 5A-5K illustrate trigger locations of one embodiment, but in other embodiments different trigger locations are used. The first and second trigger locations may be any predetermined locations.

Note that, in practice, it takes a finite amount of time for the valve 351 to fully close or open, and during this time while the valve 351 is closing or opening the inter-media zone 322 continues to move. Thus, in some embodiments, to ensure that the valve 351 is fully closed when the inter-media zone 322 reaches a desired trigger location (“nominal trigger location”), the actuator 359 may need to start closing the valve 351 shortly before the inter-media zone 322 actually reaches the nominal trigger location. In other words, an actual trigger location that is used to trigger the closing or opening may be offset from the nominal trigger location by some fixed amount to account for the finite amount of time it takes the valve 351 to close or open. The known speed of the movable support surface 320 and a known actuation time for the valve 351 may be used to determine the offset. To simplify the description, only the nominal trigger locations are discussed below.

In the embodiment of FIGS. 5A-5J, the trigger locations for each valve 351 correspond to upstream and downstream boundaries of the subsets of holes 327 blocked by the respective valve 351. In this embodiment, the holes 327 have elongated top portions 327b and the upstream/downstream edges of the holes 327 are not aligned with the upstream/downstream edges of the valves 351. Thus, the trigger locations associated with each valve 351 in this embodiment are offset slightly upstream or downstream relative to the edges of the valve 351. In other embodiments (not illustrated), the trigger locations correspond to the upstream and downstream edges of the valve 351.

FIG. 5A illustrates the inter-media zone 322 in a first position. The first position corresponds to the downstream edge of the inter-media zone 322 (i.e., the trail edge TE of the print medium 305a) reaching a first trigger location associated with the first valve 351_1. Specifically, the inter-media zone 322 reaches the first trigger location when the trail edge TE of the print medium 305a is at (i.e., vertically aligned with) the upstream boundary of the subset of holes 327 that are blocked by the first valve 351_1, or in other words at an upstream edge of the channel 327b of the most upstream hole 327 in the subset, which is labeled 327_1 in FIG. 5A. Thus, at (or shortly before) the timing when the inter-media zone 322 reaches the first trigger location, the controller causes one of the actuators 359 to move the first valve 351_1 to the closed state. Thus, later when the print media 305a moves downstream and ceases to cover the hole 327_1, the valve 351_1 is already closed and ready to block airflow through the hole 327_1, preventing the hole 327_1 from induce a crossflow 35 when it becomes uncovered. In the state illustrated in FIG. 5A, the other valves 351 associated with the same printhead module 302 are not closed because the inter-media zone 322 has not yet arrived at the trigger locations associated with those valves 351.

FIG. 5B illustrates the inter-media zone 322 at a second position. The second position corresponds to the downstream edge of the inter-media zone 322 (i.e., the trail edge TE of the print medium 305a) reaching a first trigger location associated with the second valve 351_2. Specifically, the inter-media zone 322 reaches this trigger location when the trail edge TE of the print medium 305a is at the upstream boundary of the subset of holes 327 that are blocked by the second valve 351_2, i.e., at the upstream edge of the hole 327_2. Thus, at (or shortly before) the timing when the inter-media zone 322 reaches the second position, the controller causes one of the actuators 359 to move the second valve 351_2 to the closed state. The first valve 351_1 remains closed in this state because the inter-media zone 322 has not yet fully passed the first valve 351_1, and thus both the first and second valves 351_1 and 351_2 are closed in this state. In the state illustrated in FIG. 5B, all parts of the inter-media zone 322 that are near/under the printhead 310 are blocked by the valves 351_1 and 351_2, and thus crossflows 35 that might have otherwise been induced are prevented. More specifically, the valves 351 prevent the region R₁ from being exposed to the vacuum state below the platen 326, and therefore the region R₁ and the region R₂ stay at approximately the same pressure. Because the regions R₁ and R₂ are at approximately the same pressure, there is little to no airflow induced between the regions R₂ and R₁, and hence little or no crossflows 35. Note that an upstream portion of the inter-media zone 322 is unblocked in this state, but this does not induce any significant crossflows 35 though the ink-ejection region 312 because the unblocked portion of the inter-media zone 322 is relatively distant from the ink-ejection region 312 of the printhead 310.

FIG. 5C illustrates the inter-media zone 322 at a third position. The third position corresponds to the downstream edge of the inter-media zone 322 (i.e., the trail edge TE of the print medium 105a) reaching a first trigger location associated with the third valve 351_3. Specifically, the inter-media zone 322 reaches this trigger location when the trail edge TE of the print medium 305a is at the upstream boundary of the subset of holes 327 that are blocked by the third valve 351_3, i.e., at the upstream edge of the hole 327_3. Thus, at (or shortly before) the timing when the inter-media zone 322 reaches the third position, the controller causes one of the actuators 359 to move the third valve 351_3 to the closed state. The first and second valve 351_1, 351_2 remain closed in this state because the inter-media zone 322 has not yet fully passed them. In the state illustrated in FIG. 5C, the portions of the inter-media zone 322 near/under the printheads 310 are blocked by the valves 351, and thus crossflows 35 that might have otherwise been induced are prevented.

FIG. 5D illustrates the inter-media zone 322 at a fourth position. The fourth position corresponds to the upstream edge of the inter-media zone 322 (i.e., the lead edge LE of the print medium 305b) reaching a second trigger location associated with the first valve 351_1. In the fourth position, the inter-media zone has passed the first valve 351_1. Specifically, the inter-media zone 322 reaches this trigger location when the lead edge LE of the next print medium 305b is at a downstream boundary of the subset of holes 327 blocked by the first valve 351_1, i.e., at the downstream edge of the hole 327_4. Thus, at (or shortly before) the timing when the inter-media zone 322 reaches the fourth position, the controller causes one of the actuators 359 to move the first valve 351_1 back to the open state. The second and third valve 351_2, 351_3 remain closed in this state because the inter-media zone 322 has not yet fully passed them. The opening of the first valve 351_1 allows the holes 327 in that vicinity to resume functioning in their intended role of applying hold-down force to the print medium 305b.

FIG. 5E illustrates the inter-media zone 322 at a fifth position. The fifth position corresponds to the downstream edge of the inter-media zone 322 (i.e., the trail edge TE of the print medium 305a) reaching a first trigger location associated with the fourth valve 351_4. Specifically, the inter-media zone 322 reaches this trigger location when the trail edge TE of the print medium 305a is at an upstream boundary of the subset of holes 327 blocked by the fourth valve 351_4, i.e., at the upstream edge of the hole 327_5. Thus, at (or shortly before) the timing when the inter-media zone 322 reaches the fifth position, the controller causes one of the actuators 359 to move the fourth valve 351_4 to the closed state. The second and third valves 351_2, 351_3 remain closed in this state because the inter-media zone 322 has not yet fully passed them.

FIG. 5F illustrates the inter-media zone 322 at a sixth position. The sixth position corresponds to the upstream edge of the inter-media zone 122 (i.e., the lead edge LE of print medium 305b) reaching a second trigger location associated with the second valve 351_2. In other words, in the sixth position the inter-media zone 322 has now passed the second valve 351_2. Specifically, the inter-media zone 322 reaches this trigger location when the lead edge LE of the next print medium 305b is at the downstream boundary of the subset of holes 327 blocked by the second valve 351_2, i.e., at the downstream edge of the hole 327_6. Thus, at (or shortly before) the timing when the inter-media zone 322 reaches the sixth position, the controller causes one of the actuators 359 to move the second valve 351_2 back to the open state. The third and fourth valves 351_3, 351_4 remain closed in this state because the inter-media zone 322 has not yet fully passed them.

FIG. 5G illustrates the inter-media zone 322 at a seventh position. The seventh position corresponds to the downstream edge of the inter-media zone 322 (i.e., the trail edge TE of the print medium 305a) reaching a first trigger location associated with the fifth valve 351_5. Specifically, the inter-media zone 322 reaches this trigger location when the trail edge TE of the print medium 305a is at the upstream boundary of the subset of holes 327 blocked by the fifth valve 351_5, i.e., the upstream edge of the hole 327_7. Thus, at (or shortly before) the timing when the inter-media zone 322 reaches the seventh trigger location, the controller causes one of the actuators 359 to move the fifth valve 351_5 to the closed state. The third and fourth valves 351_3, 351_4 remain closed in this state because the inter-media zone 322 has not yet fully passed them.

FIGS. 5H-5J illustrate the inter-media zone 322 at eighth through tenth positions, each corresponding to the upstream edge of the inter-media zone 122 (i.e., the lead edge LE of print medium 305b) reaching second trigger locations respectively associated with the third valve 351_3, fourth valve 351_4, and fifth valve 351_5, respectively. Specifically, the eighth through tenth positions correspond to the lead edge LE of the print medium 305b being at the downstream boundaries of the third valve 351_3, fourth valve 351_4, and fifth valve 351_5, respectively, i.e., the downstream edges of the holes 327_8, 327_9, and 327_10, respectively. Thus, when the inter-media zone 322 reaches the eighth position the third valve 351_3 is opened (FIG. 5H), when the inter-media zone 322 reaches the ninth position the fourth valve 351_4 is opened (FIG. 5J), and when the inter-media zone 322 reaches the tenth position the fifth valve 351_5 is opened (FIG. 5K).

FIGS. 6A-6B show cross-sections taken along E in FIG. 4, which illustrate the movement the valves 351 between the closed and open states. To improve clarity, only one of the valves 351 is illustrated in FIGS. 6A-6B. FIG. 6A corresponds to the state illustrated in FIG. 5A, in which the valves 351_1 is in the closed state. FIG. 6B corresponds to the state illustrated in FIG. 5F, in which the valve 351_1 has been moved to the open state.

As shown in FIG. 6A, when a valve 351 is in the closed state, the body 352 of the valve 351 is engages with the bottom of the platen 326 and/or the seals 354 that extend in the cross-process direction on opposite sides of the subset of holes 327 associated with the valve 351. Thus, in the closed state the body 352, seals 354, and/or platen 326 together block airflow through the bottom openings of the subset of holes 327. In this context, the body 352 engaging with the bottom of the platen 326 and/or the seals 354 refers to the body 352 coming into contact with the platen 326 and/or the seals 354, or coming sufficiently close to the platen 326 and/or the seals 354 to block airflow through the subset of holes 327. In this context, “blocking” a hole 327 refers to positioning the body 352 of the valve 351 such that it prevents airflow through the hole 327. In this context, “blocking” the hole 327 refers positioning the body 352 of the valve 351 such that it prevents airflow through the hole 327. In this context, “preventing” air from flowing through the holes 327 means creating a relatively high impedance state for the holes 327 such that airflow through the holes 327 is significantly reduced, as compared to a completely open state (e.g., impedance is increased by at least tenfold and/or airflow is decreased by at least 90%). Thus, blocking the holes 327 and preventing airflow does not necessarily require a hermetic seal or the strict elimination of all airflow.

As shown in FIG. 6B, when the valve 351 is in the open state, the valve 351 is rotated such that opening 353 faces the subset of holes 327 such that the opening 353 forms a passageway fluidically coupling the holes 327 to the vacuum state in the plenum 325. Thus, in the open state the valve 351 ceases to block the subset of holes 327, allowing air to flow through the holes 327.

As shown in FIGS. 6A and 6B, an actuator 359 imparts rotation to the body 352 of the corresponding valve 351, thereby causing the valve 351 to move between the closed state illustrated in FIG. 6A and the open state illustrated in FIG. 6B. In the embodiment illustrated in FIGS. 6A-6B, the actuator 359 comprises a rotary actuator whose drive output 357 comprises a rotor that the actuator 359 drives to rotate around an axis of rotation 360. The axis of rotation 360 is aligned with a longitudinal axis of the valve 351. The rotor of the actuator 359 is coupled to the valve 351, and thus the rotation of the rotor drives rotation of the valve 351.

In the embodiment illustrated in FIGS. 6A-6B, the drive output 357 of the actuator 359 is directly coupled to the valve 351, but in some embodiments (not illustrated) the drive output 357 of the actuator 359 is coupled to the valve 351 indirectly using linkages or other mechanisms, such as gear mechanisms, chain drives, etc. In the embodiment illustrated in FIGS. 6A-6B, the actuator 359 is a rotary actuator, but in other embodiments the actuator 359 may be a linear actuator, such as a solenoid, hydraulic actuator, pneumatic actuator, etc. In embodiments in which the actuator 359 is a linear actuator, a drive output (e.g., piston) of the actuator 359 may be coupled to the valve via a linkage comprising a linear-to-rotary motion conversion mechanism to convert the linear motion of the drive output into the rotation of the valve 351.

The actuator 359 is secured to one or more walls of the vacuum plenum, such as the vacuum platen 326, a bottom wall, a side wall, or an interior wall of the vacuum plenum 325, via mechanical fasteners, welding, adhesives, supports that are integral with a wall of the vacuum plenum 325, any other fastening technique. In the embodiment illustrated in FIGS. 6A-6B the actuator is positioned on an inboard side of the valve 351, but in some embodiments (not illustrated) the actuators 359 are positioned below the valve 351 and/or on an outboard side of the valve 351. The valve 351 is supported by rotatable bearings. In the embodiment of FIG. 6A-6B, one of the bearings supporting the valve 351 on an inboard side comprises the rotor of the actuator 359 and another bearing supporting the valve 351 on an outboard side comprises a shaft coupled to a wall of the vacuum plenum 325.

Although the embodiments of the airflow control systems 350 described above are illustrated and described in the context of the specific ink deposition assemblies 301 and media transport device 303 of the printing system 300, the same airflow control system 350 could be used in other embodiments of the printing system 300 having with differently configured ink deposition assemblies 301 and media transport devices 303. For example, the various embodiments of the airflow control systems 350 could be used in printing systems 300 with different types of movable support surfaces 320, printing systems 300 with different types of vacuum plenums 325, printing systems 300 with different types of vacuum platens 326, printing systems 300 with different numbers and/or types of printhead modules 302, and so on.

This description and the accompanying drawings that illustrate inventive aspects and embodiments should not be taken as limiting—the claims define the protected invention. Various mechanical, compositional, structural, electrical, and operational changes may be made without departing from the spirit and scope of this description and the claims. In some instances, well-known circuits, structures, and techniques have not been shown or described in detail in order not to obscure the invention. Like numbers in two or more figures represent the same or similar elements.

Further, the terminology used herein to describe aspects of the invention, such as spatial and relational terms, is chosen to aid the reader in understanding embodiments of the invention but is not intended to limit the invention. For example, spatially terms—such as “upstream”, “downstream”, “beneath”, “below”, “lower”, “above”, “upper”, “inboard”, “outboard”, “up”, “down”, and the like—may be used herein to describe directions or one element's or feature's spatial relationship to another element or feature as illustrated in the figures. These spatial terms are used relative to the poses illustrated in the figures, and are not limited to a particular reference frame in the real world. Thus, for example, the direction “up” in the figures does not necessarily have to correspond to an “up” in a world reference frame (e.g., away from the Earth's surface). Furthermore, if a different reference frame is considered than the one illustrated in the figures, then the spatial terms used herein may need to be interpreted differently in that different reference frame. For example, the direction referred to as “up” in relation to one of the figures may correspond to a direction that is called “down” in relation to a different reference frame that is rotated 180 degrees from the figure's reference frame. As another example, if a device is turned over 180 degrees in a world reference frame as compared to how it was illustrated in the figures, then an item described herein as being “above” or “over” a second item in relation to the Figures would be “below” or “beneath” the second item in relation to the world reference frame. Thus, the same spatial relationship or direction can be described using different spatial terms depending on which reference frame is being considered. Moreover, the poses of items illustrated in the figure are chosen for convenience of illustration and description, but in an implementation in practice the items may be posed differently.

The term “process direction” refers to a direction that is parallel to and pointed in the same direction as an axis along which the print media moves as is transported through the deposition region of the ink deposition assembly. Thus, the process direction is a direction parallel to the y-axis in the Figures and pointing in a positive y-axis direction.

The term “cross-process direction” refers to a direction perpendicular to the process direction and parallel to the movable support surface. At any given point, there are two cross-process directions pointing in opposite directions, i.e., an “inboard” cross-process direction and an “outboard” cross-process direction. Thus, considering the reference frames illustrated in the Figures, a cross-process direction is any direction parallel to the x-axis, including directions pointing in a positive or negative direction along the x-axis. References herein to a “cross-process direction” should be understood as referring generally to any of the cross-process directions, rather than to one specific cross-process direction, unless indicated otherwise by the context. Thus, for example, the statement “the valve is movable in a cross-process direction” means that the valve can move in an inboard direction, outboard direction, or both directions.

The terms “upstream” and “downstream” may refer to directions parallel to a process direction, with “downstream” referring to a direction pointing in the same direction as the process direction (i.e., the direction the print media are transported through the ink deposition assembly) and “upstream” referring to a direction pointing opposite the process direction. In the Figures, “upstream” corresponds to a negative y-axis direction, while “downstream” corresponds to a positive y-axis direction. The terms “upstream” and “downstream” may also be used to refer to a relative location of element, with an “upstream” element being displaced in an upstream direction relative to a reference point and a “downstream” element being displaced in a downstream direction relative to a reference point. In other words, an “upstream” element is closer to the beginning of the path the print media takes as it is transported through the ink deposition assembly (e.g., the location where the print media joins the movable support surface) than is some other reference element. Conversely, a “downstream” element is closer to the end of the path (e.g., the location where the print media leaves the support surface) than is some other reference element. The reference point of the other element to which the “upstream” or “downstream” element is compared may be explicitly stated (e.g., “an upstream side of a printhead”), or it may be inferred from the context.

The terms “inboard” and “outboard” refer to opposite sides of the media transport device along a cross-process direction. “Outboard” refers to the side of the media transport device closest to a registration location to which the edges of the print media are registered. “Inboard” refers to the side of the media transport device opposite from the outboard side. For example, in FIGS. 6A-6B the outboard side of the media transport device is labeled OB and the inboard side of the media transport device is labeled IB. The terms “inboard” and “outboard” are also used to refer to cross-process directions, with “inboard” referring to a cross-process direction that points from the outboard side to the inboard side and “outboard” referring to the cross-process direction that points from the inboard side to the outboard side. In the Figures, “inboard” corresponds to a positive x-axis direction, while “outboard” corresponds to a negative x-axis direction. The terms “inboard” and “outboard” also refer to relative locations, with an “inboard” element being displaced in an inboard direction relative to a reference point and with an “outboard” element being displaced in an outboard direction relative to a reference point. The reference point may be explicitly stated (e.g., “an inboard side of a printhead”), or it may be inferred from the context. Thus, for example, an “inboard side of a carrier plate” refers to a side of the carrier plate that is relatively further inboard than another side of the carrier plate.

The term “vertical” refers to a direction perpendicular to the movable support surface in the deposition region. At any given point, there are two vertical directions pointing in opposite directions, i.e., an “upward” direction and an “downward” direction. Thus, considering the reference frames illustrated in the Figures, a vertical direction is any direction parallel to the z-axis, including directions pointing in a positive z-axis direction (“up”) or negative z-axis direction (“down”).

The term “horizontal” refers to a direction parallel to the movable support surface in the deposition region (or tangent to the movable support surface in the deposition region, if the movable support surface is not flat in the deposition region). Horizontal directions include the process direction and cross-process directions.

The term “vacuum” has various meanings in various contexts, ranging from a strict meaning of a space devoid of all matter to a more generic meaning of a relatively low pressure state. Herein, the term “vacuum” is used in the generic sense, and should be understood as referring broadly to a state or environment in which the air pressure is lower than that of some reference pressure, such as ambient or atmospheric pressure. The amount by which the pressure of the vacuum environment should be lower than that of the reference pressure to be considered a “vacuum” is not limited and may be a small amount or a large amount. Thus, “vacuum” as used herein may include, but is not limited to, states that might be considered a “vacuum” under stricter senses of the term.

The term “air” has various meanings in various contexts, ranging from a strict meaning of the atmosphere of the Earth (or a mixture of gases whose composition is similar to that of the atmosphere of the Earth), to a more generic meaning of any gas or mixture of gases. Herein, the term “air” is used in the generic sense, and should be understood as referring broadly to any gas or mixture of gases. This may include, but is not limited to, the atmosphere of the Earth, an inert gas such as one of the Noble gases (e.g., Helium, Neon, Argon, etc.), Nitrogen (N₂) gas, or any other desired gas or mixture of gases.

In addition, the singular forms “a”, “an”, and “the” are intended to include the plural forms as well, unless the context indicates otherwise. And, the terms “comprises”, “comprising”, “includes”, and the like specify the presence of stated features, steps, operations, elements, and/or components but do not preclude the presence or addition of one or more other features, steps, operations, elements, components, and/or groups. Components described as coupled may be electrically or mechanically directly coupled, or they may be indirectly coupled via one or more intermediate components, unless specifically noted otherwise. Mathematical and geometric terms are not necessarily intended to be used in accordance with their strict definitions unless the context of the description indicates otherwise, because a person having ordinary skill in the art would understand that, for example, a substantially similar element that functions in a substantially similar way could easily fall within the scope of a descriptive term even though the term also has a strict definition.

Elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

What is claimed is:

1. A printing system, comprising:
an ink deposition assembly comprising one or more printheads arranged to eject ink to a deposition region of the ink deposition assembly;
a media transport device comprising a movable support surface, the media transport device configured to hold a print medium against the movable support surface by vacuum suction through holes in the media transport device and transport the print media along a process direction though the deposition region;
an airflow control system comprising a valve actuatable between an open state and a closed state, the valve blocking airflow through a subset of the holes in the closed state, and the valve allowing airflow through the subset of holes in the open state.

2. The printing system of claim 1,
an actuator operably coupled to and configured to actuate the valve; and

3. The printing system of claim 2,
a controller configured to cause the actuator to actuate the valve between the open state and the closed state to selectively block the subset of holes based on a position of an inter-media zone between adjacent print media held against the movable support surface.

4. The printing system of claim 3,
wherein the controller is configured to cause the actuator to actuate the valve from the open state to the closed state in response to a downstream edge of the inter-media zone reaching a first position relative to the valve.

5. The printing system of claim 4,
wherein the controller is configured to cause the actuator to actuate the valve from the closed state to the open state in response to an upstream edge of the inter-media zone reaching a second position relative to the valve.

6. The printing system of claim 5,
wherein the first position corresponds to an upstream boundary of the subset of holes and the second position corresponds to a downstream boundary of the subset of holes.

7. The printing system of claim 1,
wherein the subset of the holes blocked by the valve comprise one or any combination of:
holes upstream of and adjacent to one of the printheads.
holes downstream of and adjacent to one of the printheads;
holes located under one of the printheads; and
holes located under a printhead module of the ink deposition assembly, the printhead module comprising a carrier plate and a plurality of the printheads arranged to eject the printing fluid through openings in the carrier plate.

8. The printing system of claim 1,
wherein the media transport device further comprises a vacuum platen comprising a first surface over which the movable support surface moves,
wherein the holes extending through the vacuum platen; and
wherein the valve is positioned adjacent a second surface of the vacuum platen opposite to the first surface.

9. The printing system of claim 8,
wherein the valve extends across the vacuum platen in a direction perpendicular to the process direction.

10. The printing system of claim 9,
wherein the holes are arranged in rows and columns in the vacuum platen and the subset of holes blocked by the valve comprises one or more rows of holes.

11. The printing system of claim 8,
wherein the movable support surface comprises a belt.

12. The printing system of claim 1,
wherein the airflow control system comprises a plurality of valves, the valve being one of the plurality of valves, each of the plurality of valves being independently actuatable between open and closed states.

13. The printing system of claim 12,
wherein the airflow control system further comprises a plurality of actuators, each of the plurality of actuators operably coupled to a respective on of the plurality of valves and configured to actuate the respective one of the plurality of valves between the open and closed states.

14. The printing system of claim 13,
further comprising a controller configured to cause the actuators to independently actuate the plurality of valves between the open and closed states based on the position of an inter-media zone.

15. The printing system of claim 1,
wherein the valve comprises a valve body having a longitudinal axis and one or more passages extending diametrically radially through the valve body, and
wherein the valve is rotatable about the longitudinal axis so as to move the one or more passages into flow communication with the subset of holes in the open state of the valve.

16. A method, comprising:
transporting a print medium through a deposition region of a printhead of a printing system, wherein the print medium is held during the transporting against a movable support surface of a media transport device via vacuum suction through holes in the media transport device;
ejecting print fluid from the printhead to deposit the ink to the print medium in the deposition region; and
controlling an airflow control system to selectively block a subset of the holes by actuating a valve between a closed state in which the valve blocks airflow through the subset of the holes and an open state in which the valve does not block airflow through the subset of the holes.

17. The method of claim 16,
wherein selectively blocking the subset of holes comprises actuating the valve between the closed state and the open state based on a position of an inter-media zone between adjacent print media held against the movable support surface

18. The method of claim 17,
wherein selectively actuating the valve comprises:
actuating the valve from the open state to the closed state in response to a downstream edge of the inter-media zone reaching a first position relative to the valve; and
actuating the valve from the closed state to the open state in response to a downstream edge of the inter-media zone reaching a second position relative to the valve.

19. The method of claim 16,
wherein selectively actuating the valve comprises causing an actuator coupled to the valve to rotate a body of the valve.

20. The method of claim 16,
wherein actuating the valve comprises rotating the valve about a longitudinal axis of the valve to place one or more passages extending diametrically through the valve in flow communication with the holes in the open state and to position the valve to block airflow through the holes in the close state, the longitudinal axis extending perpendicular to a process direction.
